(19) United States
(12) Patent Application Publication
(10) Pub. No.: US 2015/0143959 A1
(43) Pub. Date: May 28, 2015

(54) STRIKING TOOL

(71) Applicant: SHOU KING ENTERPRISE CO., LTD., Taichung (TW)

(72) Inventor: Ching-Chou Lin, Taichung (TW)

(73) Assignee: SHOU KING ENTERPRISE CO., LTD., Taichung (TW)

(21) Appl. No.: 14/089,993

(22) Filed: Nov. 26, 2013

(51) Int. Cl. B25D 1/12; B25D 1/14; B25D 1/02

(52) U.S. Cl. CPC B25D 1/12; B25D 1/02; B25D 1/14
USPC 81/22

(57) ABSTRACT

A striking tool for pounding or hammering is revealed. The striking tool includes a handle, a neck and a head. The neck is extended from one end of the handle and the head is formed by extension of one end of the neck. The neck has resilience. The head consists of a first head threaded with a first striking element and a second head threaded with a second striking element. The design of the structure minimizes bounce of the handle.

### BACKGROUND OF THE INVENTION

1. Field of the Invention

The present invention relates to a striking tool, especially to a striking tool such as a hammer and the like that hits workpiece and reduces bounce of a handle.

2. Description of Related Art

Hammers have various uses including driving nails, striking working surfaces or workpiece, and other actions. Users such carpenters or joiners repeat striking thousand times while using the hammer. Although the hammer is for striking workpiece, it causes stress on the elbow or wrists while working with the hammer. Moreover, the striking force rebounds through the handle to act on user's hand and arm. Thus a serious health problem occurs due to stress and rebound force. Once the damage has been done, it is permanent and this even results in the inability to do work.

Refer to U.S. Pat. No. 6,595,087, a dead blow hammer is revealed. The hammer includes an elongated head having a longitudinal axis, a neck tube integral with the head and projecting therefrom and inclined with respect to the longitudinal axis, a handle including a member having a proximal working end received in the neck tube and a distal end, and a spacer disposed in the neck tube between the head and the working end of the member of the handle. The head tube is a cylindrical tube that includes ends thereof closed by end caps having cylindrical flanges press-fitted in the ends of the head tube. A rebound-inhibiting material is disposed in the head tube. The rebound-inhibiting filler material can be flowable material or rigid pellets such as steel shot. By the flow of the material back and forth between impact ends of the head, rebound is minimized.

Refer to U.S. Pat. No. 6,945,138, a recoiled striking device is revealed. A spring arranged at one end of a handle is compressed and the shock of the strike is absorbed when the striking device is brought to contact with an object it is desired to strike such as a nail. The compression of the spring absorbs all or a substantial amount of the shock force that would normally be transmitted to the handle when the head strikes the object. Subsequent to the strike, the compression spring immediately expands to move the head back into the normal or pre-strike orientation in readiness for the next strike.

However, the structure of the above hammer/striking device for reducing rebound or shock is complicated and expensive. In U.S. Pat. No. 6,595,087, the hammer features on that the rebound-inhibiting material disposed in the head tube. However, the effect of reducing rebound is limited. Users still receive vibration and rebound transmitted from a striking surface of the hammer to the handle.

As to the striking device revealed in U.S. Pat. No. 6,945,138, a compression spring is used to absorb the shock. After repetitive operations, the connection among different components is easy to get deformed. This affects the stability of the striking force. Thus there is room for improvement and a need to provide a novel striking tool that solves the above problems.

### SUMMARY OF THE INVENTION

Therefore it is a primary object of the present invention to provide a striking tool that overcomes shortcomings of the conventional hammer and having simple structure as well as easy operation. The striking tool includes a bouncing device on the handle so as to reduce rebound or shock on user's hand and arm.

It is another object of the present invention to provide a striking tool in which a head made from different materials is changed easily. And the manufacturing cost of the striking tool is low. It is a further object of the present invention to provide a striking tool that has improved weight distribution, ergonomic design and minimized rebound without lowering striking efficiency.

In order to achieve the above objects, a striking tool for pounding or hammering of the present invention includes a handle, a neck and a head. One end of the handle is extended to form the neck and one end of the neck is extended to form the head.

The connection between the neck 12 and the head 13 has resilience. The neck is formed by a plurality of projecting rings and a plurality of concave parts connected and arranged in an alternating manner. The other end of the neck is disposed with a grip end.

The head consists of a first end and a second end. A counterweight portion including a first threaded part and a second threaded part is arranged between the first end and the second end. The first threaded part and the second threaded part are respectively engaged with a first striking element and a second striking element. Both the first and the second striking elements include a contact part and a threaded rod. An end surface of the contact part is extended to form the threaded rod. Thus the first striking element and second striking element are respectively threaded and assembled with the first end and the second end of the head.

The striking tool features on that the neck is resilient so as to absorb rebound generated during striking and reduce vibration users feel at the handle.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive cross sectional view of a head of an embodiment according to the present invention;

FIG. 2 is an assembled cross sectional view of a head of an embodiment according to the present invention;

FIG. 3 is an explosive view of an embodiment according to the present invention;

FIG. 4 is a perspective view of an embodiment according to the present invention.

### DETAILED DESCRIPTION OF THE PREFERRED EMBODIMENT

The objects, features and functions of the present invention are described in details in following embodiments with reference to the figures.

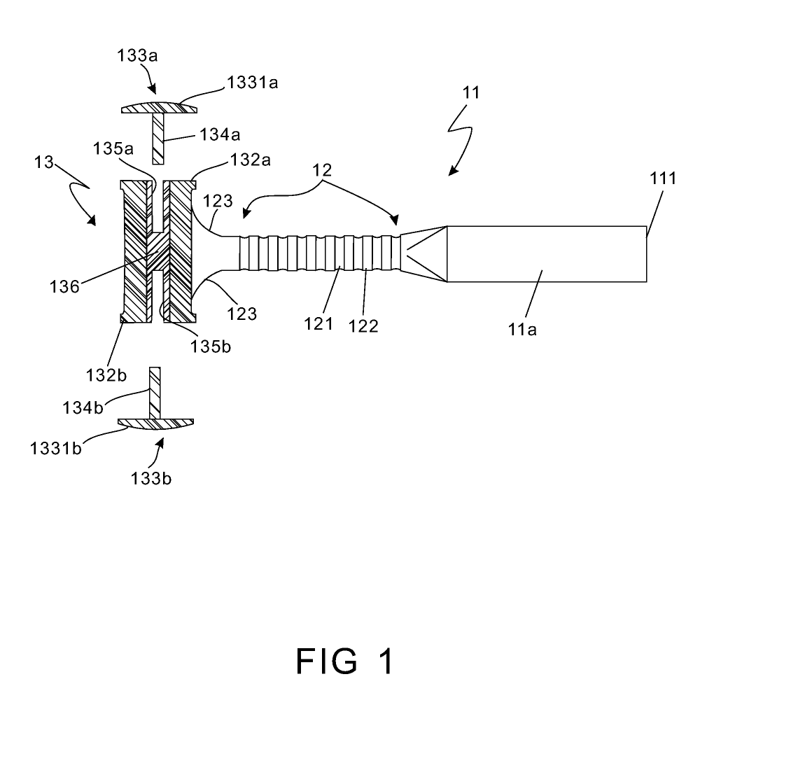

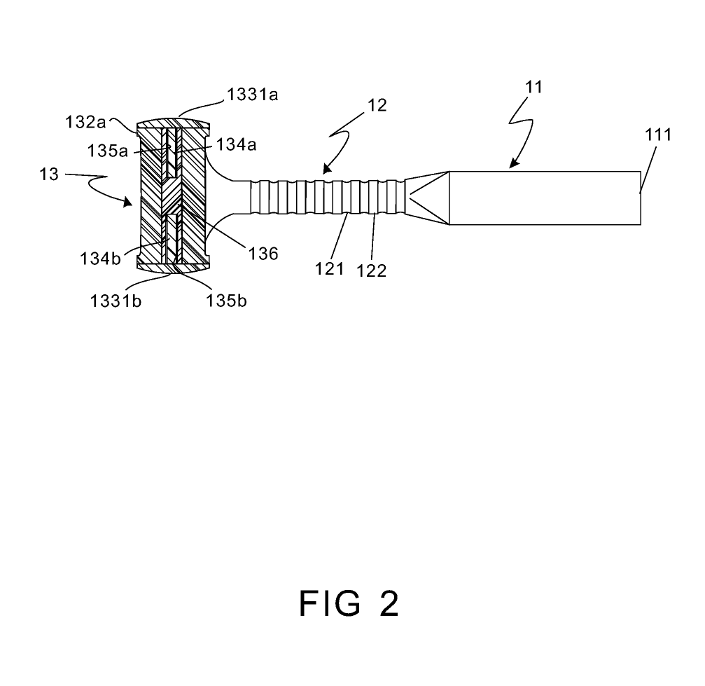

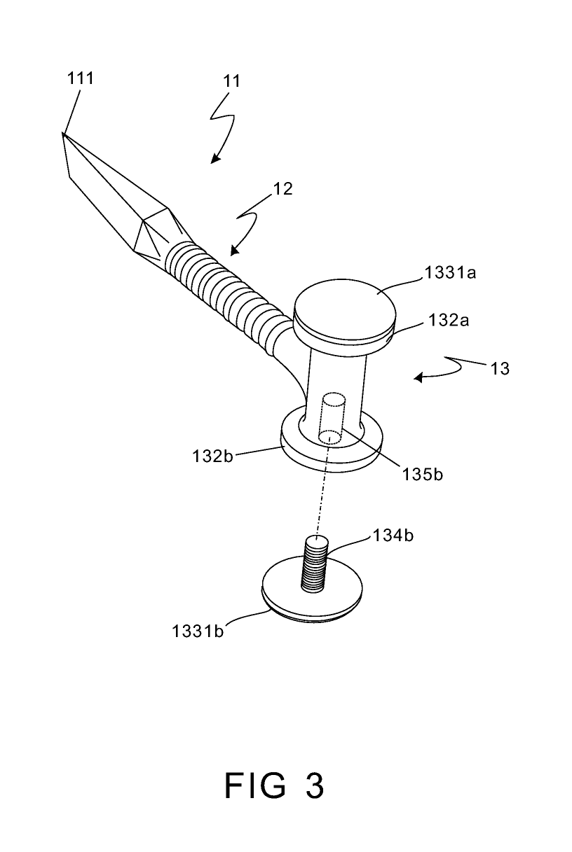

Refer from FIG. 1 to FIG. 3, a striking tool of the present invention includes a handle 11 with a longitudinal axis. The handle 11 consists of a neck 12 and a grip end 11a. A head 13 is extended and projecting from the neck 12 and a reinforcing part 123 is disposed between the head 13 and the neck 12. The handle 11 and the head 13 form a main body of the striking tool.

One end of the neck 12 is extended to form the head 13. The connection between the neck 12 and the head 13 has resilience. The neck 12 is formed by a plurality of projecting rings/circular convex parts 122 and a plurality of concave parts 121 arranged and connected in an alternating manner. An outer diameter of the projecting ring 122 is larger than an outer diameter of the concave part 121. An end surface of the 122 is extended and getting tapered conical shaped. Then the tapered conical end is changed to a truncated conical end that is integratedly connected to an end surface of another projecting ring 122. One projecting ring 122 extended and connected to one concave part 121 forms a unit. Then the unit is connected to another projecting ring 122 and concave part 121. A plurality of units forms the neck 12. The outer diameter of the neck 12 is smaller than that of the grip end 11a. The grip end 11a is wedge-shaped. The wedge is a piece thick at one edge and tapered to a thin edge 111 at the other. The thin edge 111 is used for splitting or separating two objects.

The head 13 is composed a first end 132a, a second end 132b, and a counterweight portion 136 arranged between the first end 132a and the second end 132b. The head 13 is made from plastic. The counterweight portion 136 is covered by the head 13 while a first threaded part 135a and a second threaded part 135b are exposed. The counterweight portion 136 is made from metal while the material for the head 13 is plastic. The plastic head 13 encloses the metal counterweight portion 136. The first threaded part 135a and the second threaded part 135b are arranged concavely along an axial central line of the counterweight portion 136, but not communicating to each other. The first threaded part 135a and the second threaded part 135b are a ring groove having female thread and engaged with a threaded rod 134a, 134b of a first striking element 133a and a second striking element 133b respectively. Both the first striking element 133a and the second striking element 133b include a contact part 1331a, 1331b. An end surface of the contact part 1331a, 1331b is extended to form the threaded rod 134a, 134b. By the threaded rod 134a, 134b, the first striking element 133a and the second striking element 133b are respectively threaded with and arranged at the first end 132a and the second end 132b of the head 13.

The materials for the contact parts 1331a, 1331b can be metal, plastic, wood, etc according to users' requirements. For example, while the carpenter uses the striking tool to pound wood, the contact part 1331a made from metal is required to hit nails while the contact part 1331b for striking wood board or block is made from soft and elastic materials. Thus one end of the head 13 is threaded with the metal contact part 1331a while the other end thereof is threaded with the plastic contact part 1331b. There is no need to use two striking tools made from different materials. Thus the striking tool of the present invention has many applications.

The striking tool of the present invention also has many other advantages. The head 13 can be formed by the assembly of the contact parts 1331a, 1331b made from different materials. The neck 12 of the handle 11 extended from the head 13 is resilient while the handle 11 is completely made from plastic. The handle 11 is solid, without containing any metal component in a core thereof. That means no metal component is mounted in the handle 11. The counterweight portion 136 is disposed in a core of the head 13 so as to increase the striking force of the head 13. The shock or rebound is absorbed by the resilience of the neck 12 while the head 13 striking the object. Thus the shock/rebound force delivered to user's hand is minimized. Thus injuries to user's hand, wrist and arm can be reduced.

The main body of the striking tool of the present invention is formed by plastic molding completely except the counterweight portion 136 covered by plastic and mounted in the head 13, the first striking element 133a and the second striking element 133b.

Moreover, the plastic material for the main body of the striking tool is plastic with bit resilience such as thermoplastic elastomer (TPE), thermoplastic rubber (TPR), ethylene vinyl acetate (EVA), polyamide (PA, nylon), etc. Due to the feature of the plastic, the neck 12 on the handle 11 provides resilience.

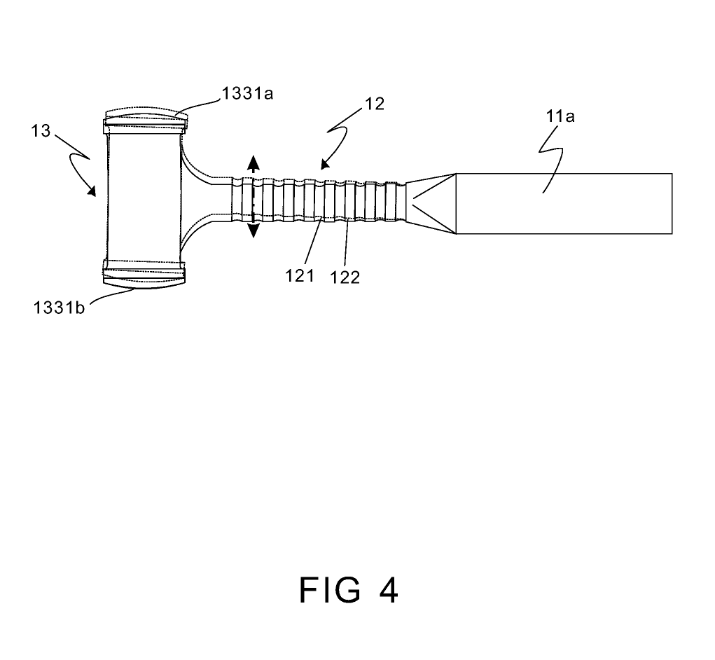

As shown in FIG. 4, the neck 12 absorbs the vibration generated during the striking process due to the resilience thereof. Thus the vibration or the impact is reduced. Otherwise the rebound force delivered to the handle 11 during the hammering will cause uncomfortable feeling to user's hand.

Furthermore, both the handle 11 made from light-weight material such as plastic and the head 13 mounted with the metal counterweight portion 136 improve weight distribution of the striking tool without reducing weight of the striking tool required for striking. Most of the weight has shifted from the handle 11 to the head 13. Thus the striking center of the head 13 has moved forward more and this allows the head 13 releases the striking force while in use. In addition, there is a reinforcing part 123 disposed at the connection area between the head 13 and the neck 12. The reinforcing part 123 is curved and extended from the head 13 to the neck 12. The radial end surface of the reinforcing part 123 connected to the head 13 has maximum area and the area is tapered from the head 13 to the neck 12. Such curved design enhances the connection between the head 13 and the neck 12. The reinforcing part 123 is not only a reinforcing structure but also helpful to the resilience of the neck 12.

In summary, the striking tool of the present invention has a simple and economic structure, improved weight distribution, maximum striking force, higher vibration/shock resistance and comfortable ergonomic design.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A striking tool comprising
a handle,
a neck formed by extension of one end of the handle, and
a head formed by extension of one end of the neck;
wherein the neck is resilient and having a plurality of projecting rings and a plurality of concave parts connected and arranged in an alternating manner; the head includes a first end, a second end, and a counterweight portion while the counterweight portion having a first threaded part and a second threaded part that are respectively engaged with a first striking element and a second striking element; both the first striking element and the second striking element include a contact part and a threaded rod; an end surface of the contact part is extended to form the threaded rod; the first striking element and second striking element are respectively threaded with and connected to the first threaded part and the second threaded part by the threaded rods.

2. The device as claimed in claim 1, wherein the other end of the neck is disposed with a grip end.

3. The device as claimed in claim 1, wherein the first striking element and the second striking element are respectively threaded on the first end and the second end of the head.

4. The device as claimed in claim 1, wherein a reinforcing part is disposed between the head and the neck; the reinforcing part is curved and is extended from the head to the neck.

5. The device as claimed in claim 4, wherein a radial end surface of the reinforcing part connected to the head has maximum area and area of the radial end surface is tapered from the head to the neck.

6. The device as claimed in claim 1, wherein the head and the handle are produced by plastic molding; the counterweight portion is mounted in and covered by the head completely.

7. The device as claimed in claim 1, wherein the first threaded part and the second threaded part of the counterweight portion are not communicating with each other.

8. A striking tool comprising
a handle,
a neck formed by extension of one end of the handle, and
a head formed by extension of one end of the neck and having a first end, a second end, and a counterweight portion; the counterweight portion having a first threaded part and a second threaded part that are respectively threaded with a first striking element and a second striking element; both the first striking element and the second striking element include a contact part and a threaded rod formed by extension of an end surface of the contact part; the first striking element and second striking element are respectively threaded with and connected to the first threaded part and the second threaded part by the threaded rods; wherein the neck is resilient and having a plurality of projecting rings and a plurality of concave parts connected and arranged in an alternating manner.

9. The device as claimed in claim 8, wherein the head and the handle are produced by plastic molding.

10. The device as claimed in claim 8, wherein the handle is a solid body without being mounted with any metal component therein.
